(19) United States
(12) Patent Application Publication
(10) Pub. No.: US 2010/0066201 A1
(43) Pub. Date: Mar. 18, 2010

(54) Electric motor

(75) Inventors: Andreas Engel, Murten (CH); Yvan Bourqui, Corminboeuf (CH); Rolf Weber, Schliern (CH); Michael Watzek, Courgevaux (CH)

Correspondence Address: FOLEY AND LARDNER LLP;SUITE 500, 3000 K STREET NW, WASHINGTON, DC, 20007, US

(73) Assignee: Saia-Burgess Murten AG

(21) Appl. No.: 12/232,377

(22) Filed: Sep. 16, 2008

(51) Int. Cl. H02K 1/18

(52) U.S. Cl. 310/257

(57) ABSTRACT

According to a first aspect the electric motor comprises the following components:
a first stator member with n1 teeth, a second stator member with n2 teeth, and a third stator member with n3 teeth;
a first connecting element that is in contact with the first and the third stator member, and a second connecting element that is in contact with the second and the third stator member.

A tooth of the third stator member is arranged between a tooth of the first stator member and a tooth of the second stator member and n3 is greater than the sum of n1 and n2.

According to a second aspect the stator of the electric motor comprises a first stack of sheet metal pieces that are joined to each other and a first stator plate. The stator plate is welded to the narrow sides of said sheet metal pieces.

### FIELD OF THE INVENTION

The present invention relates to an electric motor comprising a stator.

### BACKGROUND OF THE INVENTION

To drive the rotor, magnetic circuits (“iron circuits”) are produced in the stator of the electric motor by supplying the coils of the electric motor with current in a suitable manner.

The disclosure JP-A-10 094237 describes an electric motor that has two stator units for producing two magnetic circuits, each comprising an upper stator member, a lower stator member, and a coil arranged therebetween. During manufacture, the two stator units that are first connected to each other are separated. However, the separation into two separate stator units and thus into two separate magnetic circuits leads to a reduced motor power. In particular, the outermost teeth of the stator units do not form pronounced poles as the magnetic flux produced by the respective coil and flowing through these outermost teeth cannot be conducted to an adjacent tooth and will therefore seek another, undefined path. This part of the magnetic flux is lost, so to speak, and does not contribute to the torque of the electric motor.

A similar electric motor is known from European patent application EP 1 471 620 A2. For an improved mechanical stability, the two stator units are connected to one another by the use of integral stator plates. The interconnecting portions are provided with slit cuts to separate the two magnetic circuits from each other. This electric motor also suffers from the disadvantage that the magnetic flux is not optimally conducted due to the separation, thereby reducing the torque and the power of the electric motor.

Furthermore, the stator known from EP 1 471 620 A2 comprises stacks of sheet metal pieces with protrusions, which engage in holes being formed in stator plates. A mechanical connection of this kind has the disadvantage that the electric motor tends to produce vibrations and thus excessive noise in operation. Furthermore, the stacks of sheet metal pieces do not have perfectly plane contact surfaces so that a material free space results at the junction between the stack and the stator plate. This space causes a magnetic contact resistance and thus a reduction of the motor power.

Other stators comprising one or more stacks of sheet metal pieces are known from DE 41 01 666 A1, U.S. Pat. No. 3,382,573, and EP 1 128 524 A2.

GB 2 248 728 A describes another electric motor that comprises four stator members having five teeth each.

### SUMMARY OF THE INVENTION

It is an object of the present invention to provide an electric motor that has an improved performance.

According to a first aspect of the invention this is accomplished by an electric motor wherein the three stator members are each made of one piece and n3 is greater than the sum of n1 and n2, n1 denoting the number of teeth of the first stator, n2 the number of teeth of the second stator member, and n3 the number of teeth of the third stator member. A tooth of the third stator member is arranged between a tooth of the first stator member and a tooth of the second stator member. This arrangement allows the two magnetic circuits to be coupled to each other, thereby providing an increase in torque and power.

According to a second aspect of the invention the stator of the electric motor comprises a first stack of sheet metal pieces that are joined to each other and a first stator plate that is welded to the narrow sides of said sheet metal pieces. The magnetic properties of the stator are improved and the electric motor has an improved performance.

Further specific constructional features and the advantages thereof will be apparent from the following description.

### BRIEF DESCRIPTION OF THE DRAWINGS

The invention will be explained by means of exemplary embodiments and with reference to figures.

FIG. 1 shows a perspective view of a stator of an electric motor of the invention;

FIG. 2 shows the stator of FIG. 1 in an top view;

FIG. 3 shows the stator of FIG. 1 in an exploded view from behind;

FIG. 4 shows the stator of FIG. 1 in an exploded view from above;

FIG. 5 shows a perspective view of an electric motor of the invention with a stator according to FIG. 1, the gear unit and the rotor being omitted;

FIG. 6 shows an enlarged detail view of the stator of FIG. 1 in which magnetic flux lines are illustrated;

FIG. 7 shows an enlarged detail view of a stator of the prior art where the two magnetic circuits are separated by a slot;

FIG. 8 shows an actuator including an electric motor of the invention;

FIG. 9 shows the actuator of FIG. 8 without the housing cover;

FIG. 10 shows another embodiment of the stator of an electric motor of the invention in a side view before assembling;

FIG. 11 shows the stack of the stator of FIG. 10 in a detail view; and

FIG. 12 shows the stack of FIG. 11 in the assembled state of the stator.

### DETAILED DESCRIPTION OF THE PREFERRED EMBODIMENTS

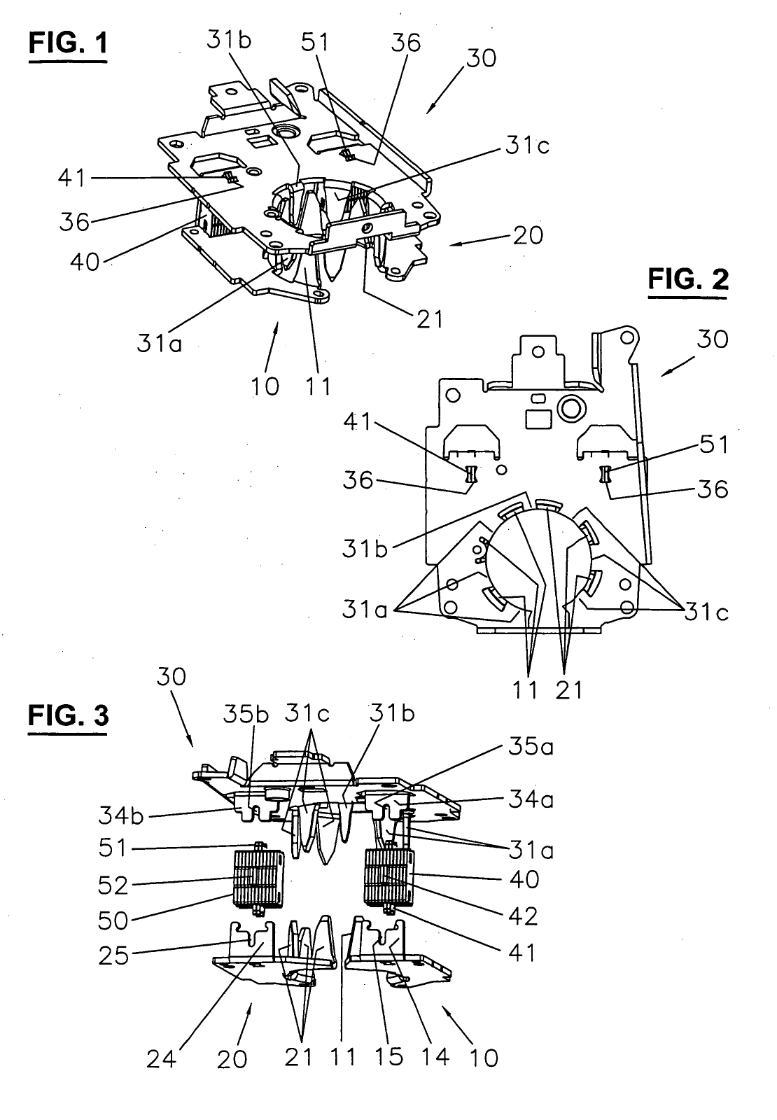

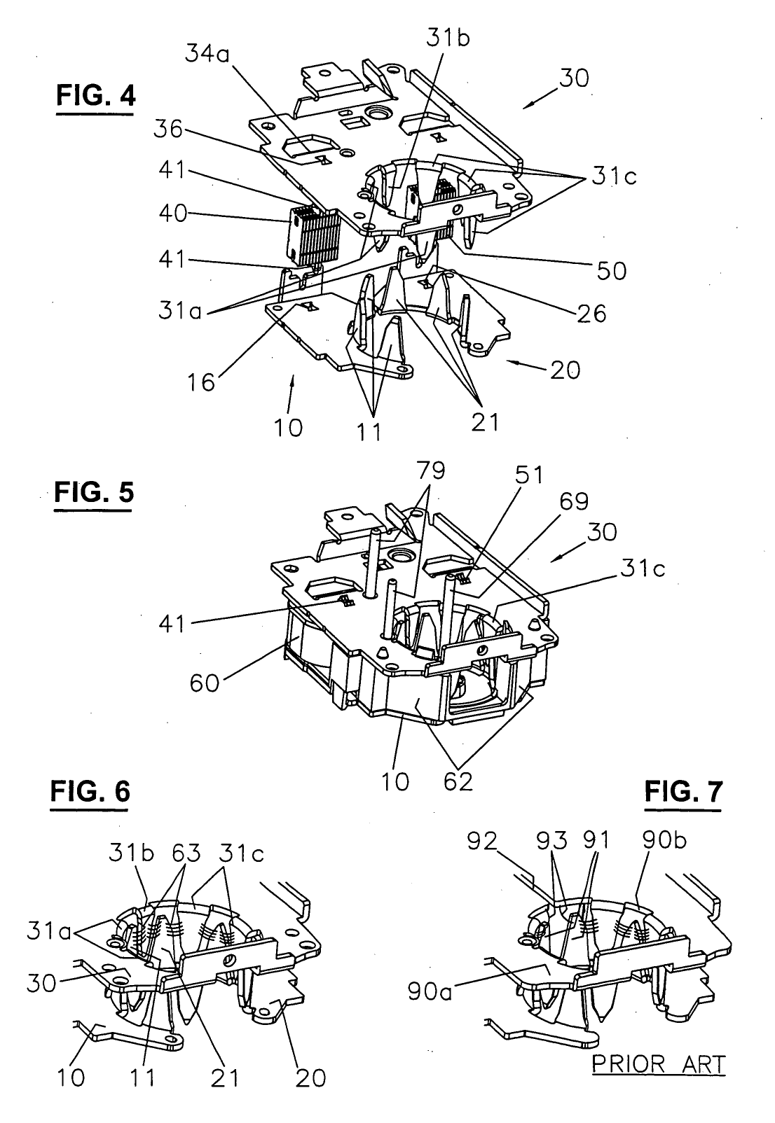

As shown in FIGS. 1 to 4, the stator comprises a first stator member 10, a second stator member 20, and a third stator member 30 as well as a first connecting element 40 that is in contact with the first stator member 10 and third stator member 30 and a second connecting element 50 that is in contact with the second stator member 20 and third stator member 30. The stator is part of an electric motor e.g. in the form of a brushless electric motor such as a stepping motor or a brushless DC motor.

First stator member 10 and second stator member 20 are shaped substantially mirror symmetrically to one another and arranged in the same plane. Third stator member 30 is arranged opposite to first and second stator members 10, 20. Stator members 10, 20, 30 are each made in one piece and comprise teeth 11, 21, 31a, 31b, 31c which serve for forming poles and jointly form a cage in which the rotor is received. Teeth 11, 21, 31a, 31b, 31c are mutually interposed and have tapered ends.

Hereinafter, n1 denotes the number of teeth 11 of first stator member 10, n2 the number of teeth 21 of second stator member 20, and n3 the number of teeth 31 of third stator member 30. The number of teeth 11, 21, 31a, 31b, 31c is chosen such that n1+n2+1=n3. In the present example, n1=3, n2=3, and n3=7. The numbers n1, n2, and n3 are adapted to the design of the electric motor, for example, n1, n2 and n3 are chosen in accordance with the desired step angle that the rotor is to be rotated in one step.

The teeth 11 of first stator member 10 and the teeth 21 of second stator member 20 are arranged so as to be located each between two teeth 31 of third stator member 30. Accordingly, third stator member 30 comprises an additional tooth 31b that is arranged between a tooth 11 of first stator member 10 and a tooth 21 of second stator member 20. On both sides of tooth 31b, teeth 11, 31a and teeth 21, 31c are arranged with the same number, which is 6 teeth in the example shown here. The top surface of the third stator member 30 that is located around the additional tooth 31b is closed and has no slit.

As explained in more detail below, the additional tooth 31b simultaneously serves for the formation of the left and right magnetic circuits.

The two connecting elements 40, 50 are designed alike and are substantially cuboidal and, for connecting purposes, comprise each prolongations 41, 51 on their upper and lower sides and prolongations 42, 52 on their front sides. Connecting elements 40, 50 are formed of packets or stacks of interconnected, soft magnetic sheet metal pieces. The two innermost sheet metal pieces of each stacks are provided with the prolongations 41, 42 or 51, 52. The sheet metal pieces of connecting elements 40 and 50 are arranged such that their respective narrow sides contact the first stator member 10 and third stator member 30 or the second stator member 20 and third stator member 30.

As appears particularly in FIG. 3, the third stator member 30 has two bent tongues 34a and 34b. The ends of tongues 34a and 34b are provided with respective openings 35a and 35b in the form of incisions into which the upper parts of the respective forward prolongations 42 and 52 are inserted. Tongues 34a, 34b are formed integrally with third stator member 30 and are produced by punching out the area of stator member 30 that is to form the respective tongue 34a, 34b and bending it by substantially 90 degrees.

First stator member 10 has an orthogonally bent tongue 14 that is formed integrally with stator member 10. The end of tongue 14 is provided with an opening 15 in the form of an incision into which the lower part of forward prolongation 42 of first connecting element 40 is inserted.

Second stator member 20 is provided with a tongue 24 of the same kind as tongue 14 of first stator member 10, opening 25 of tongue 24 receiving the lower part of forward prolongation 52 of second connecting element 50.

Tongue 34a of third stator member 30 is mechanically connected to tongue 14 of first stator member 10. To this end, on both sides of opening 35a, tongue 34a is provided with projections that cooperate with lateral projections of tongue 14 such that the end of tongue 34a locks in the end of tongue 14 and is firmly secured therein. At the same time, prolongation 42 is firmly retained in openings 15 and 35a.

The ends of the two tongues 24 and 34b are designed like the ends of the two tongues 14 and 34a and are mechanically interconnected in a corresponding manner.

Stator members 10, 20, 30 are provided with openings 16, 26, 36 in the form of slots having each a constricted portion. Upper and lower prolongations 41, 51 of connecting elements 40, 50 are clamped inside openings 16, 26 and 16, 36, respectively, so that connecting element 40 is pressed against stator members 10 and 30 and connecting element 50 against stator members 20 and 30.

The design of the bent tongues 14, 24, 34a, 34b results in an L-shaped configuration of stator members 10, 20, 30 in the area of contact with connecting elements 40, 50 and thus in an increased contact area between connecting elements 40 and 50 and stator members 10, 30 and 20, 30, respectively. This increase of the contact surface area results in a reduction of the magnetic contact resistance between the individual stator members 10, 20, 30 and thus in an improved motor performance. Prolongations 41, 42, 51, 52 and openings 15, 16, 25, 26, 35a, 35b, 36 are so designed that connecting elements 40 and 50 are pressed on stator members 10, 30 and 20, 30, respectively, thereby reducing the air gap therebetween. This measure also contributes to a reduction of the magnetic contact resistance and to an even more improved motor performance.

To magnetize the stator, the electric motor comprises two coils 60 whose windings are arranged around connecting elements 40, 50 and tongues 14, 34a, 24, 34b. A one-piece coil carrier serves as a support for the two coils 60. FIG. 5 further illustrates rotation axle 69 for the rotor. Coils 60 are arranged adjacent to each other. The rotation axle 69 of the rotor is arranged outside the area which is located between the two coils 60 and thus between the two connecting elements 40 and 50. This arrangement allows a particularly compact construction. The close vicinity of the two coils 60 further allows a simple wiring thereof with terminal pins for the connection of a cable provided with a connector.

To stabilize the stator mechanically, stator members 10, 20, 30 are fastened to the coil carrier e.g. by welding and/or by clip connections. In the area of the cage, two side walls 62 are arranged which connect third stator member 30 to stator members 10 and 20.

Third stator member 30 is designed so as to directly serve as a support for a gear assembly. As seen in FIG. 5, gear axles 79 are fastened directly in stator member 30.

The rotor is permanently magnetized, the north and south poles being arranged around the axis of rotation in the form of stripes. In the example shown here, in which n1+n2+n3=13, the number of pole pairs of the rotor is seven. To drive the rotor, an electronic circuit supplies coils 60 with current such that an alternating magnetic field is produced. Hereinafter, the currents flowing in the two coils 60 will be denoted as follows:
A: current flowing in the first coil while it produces a magnetic field directed from first stator member 10 to third stator member 30 so that teeth 11 of first stator member 10 form north poles;
A′: current flowing in the first coil while it produces a magnetic field directed from third stator member 30 to first stator member 10 so that teeth 11 of first stator member 10 form south poles;
B: current flowing in the second coil while it produces a magnetic field directed from second stator member 20 to third stator member 30 so that teeth 21 of second stator member 20 form north poles;
B′: current flowing in the second coil while it produces a magnetic field directed from third stator member 30 to second stator member 20 so that teeth 21 of second stator member 20 form south poles.

Coils 60 are supplied with current according to the scheme AB/A′B/A′B′/AB′/AB/etc. During each particular current supply mode, teeth 11, 21, 31a, 31b, 31c form poles as follows, whereby “+” denoting a north pole and “−” a south pole:

| | teeth 31a | teeth 11 | tooth 31b | teeth 21 | teeth 31c |
|---|---|---|---|---|---|
| AB | − | + | − | + | − |
| A′B | + | − | +/− | + | − |
| A′B′ | + | − | + | − | + |
| AB′ | − | + | −/+ | − | + |

As seen in the table, tooth 31b cooperates both with the magnetic circuit produced by the first coil and with the magnetic circuit produced by the second coil. In particular, one side of tooth 31b forms a south pole and the other side of tooth 31b a north pole when coils 60 are supplied with current according to A′B and AB′. Consequently, rather than acting as two separate stator members, third stator member 30 allows a magnetic interference between the left and right sides of the stator in a predetermined manner.

Providing an additional tooth 31b allows the produced magnetic flux to be conducted from tooth 11 of first stator member 10 that is arranged adjacent to tooth 31b, via tooth 31b of third stator member 30, to tooth 21 of second stator member 22 that is arranged adjacent to tooth 31b. This is indicated in FIG. 6 by magnetic flux lines 63. Consequently, a pronounced pole is also formed on the two teeth 11, 21 adjacent to tooth 31b, thereby increasing the produced torque and thus the motor power.

It is known in the art to design the stator such that the two magnetic circuits are separated from each other by providing a slot 92 instead of tooth 31b, as shown in the detail view of FIG. 7. The teeth 91 adjacent to slot 92 have a reduced effectiveness as the magnetic flux is conducted from these teeth 91 to the upper stator members 90a and 90b on a path that is not specifically determined. This is indicated in FIG. 6 by magnetic flux lines 93. The produced torque is thereby reduced.

The manufacture and assembly of the stator are accomplished as follows:

Stator members 10, 20, 30 and the sheet metal pieces for connecting elements 40, 50 are punched out of soft magnetic sheet metal, preferably a soft magnetic steel sheet (“electric sheet metal”). The punched stator members 10, 20, 30 are bent and the individual sheet metal pieces are joined to form connecting elements 40 and 50, e.g. by a punctual deformation of the sheet metal pieces by means of a punch and die assembly that produces a mechanical connection (“punch stacking”).

The lower and forward prolongations 41, 42 and 51, 52 of connecting elements 40, 50 are pushed into the corresponding openings 15, 16, 25, 26 and then the coil carrier along with coils 60 is put over tongues 14, 24 and connecting elements 40, 50. Subsequently, third stator member 30 is fitted so that forward prolongations 42, 52 are pressed into openings 35a, 35b and the ends of tongues 34a, 34b into the ends of tongues 14, 24.

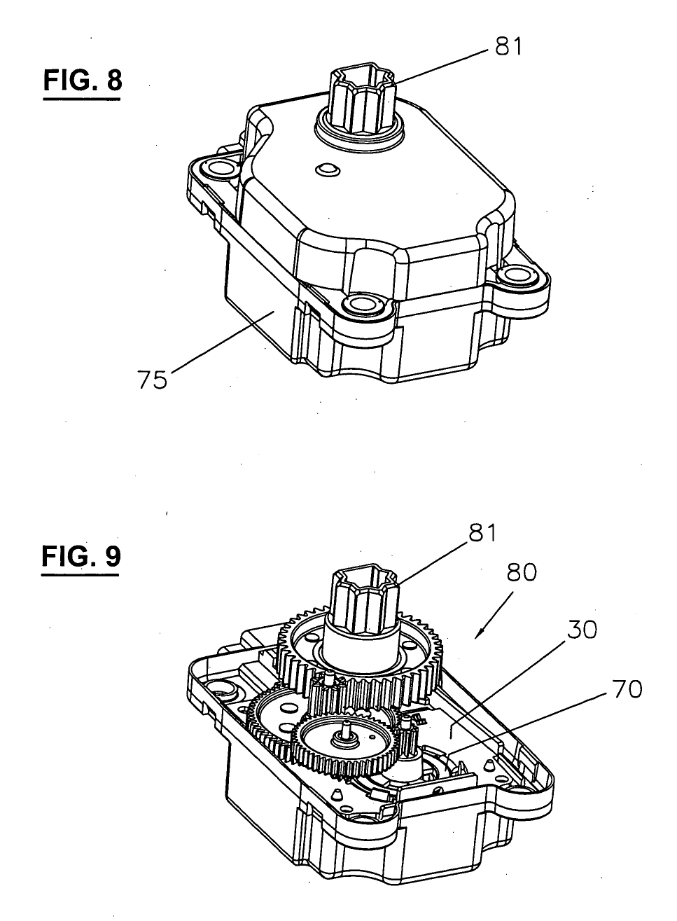

FIGS. 8 and 9 show an actuator comprising an electric motor of the invention with the assembled stator. The lower part of the housing 75 is trough-shaped. The first and second stator members are fastened inside housing 75 by hot stamping. Third stator member 30 is affixed to supporting surfaces of housing 75. The cage formed by the teeth of the stator members encloses a cylindrical rotor 70. The two coils and the rotor 70 are located substantially in the same plane, thereby allowing a relatively flat construction of the electric motor. The actuator includes a gear assembly 80 that is coupled to the rotor 70 and that has an output shaft 81.

The actuator is for instance suitable for the controlled actuation of a movable component in a motor vehicle such as a ventilation flap in the heating, ventilation and/or air conditioning system, a headlight, or a headlight component.

The depicted concept of the electric motor and particularly of the stator provides the following advantages, among others:
By providing an additional pole on the third stator member, the two magnetic circuits are coupled to one another such that a higher torque and a higher motor power can be produced.
The manufacture of the stator is relatively simple and cost-efficient. In particular, the sheet metal pieces both for the stator members and for the connecting elements can be produced by punching.
The connecting elements can be produced from the same high-grade material as the stator members. This ensures that the magnetic flux lines produced when the coils are supplied with current are optimally conducted between the individual stator members.
The connecting element can be designed such that the contact surfaces between the connecting element and the stator member are as large as possible. This also results in a reduced magnetic contact resistance.

In the assembled state as shown in FIG. 1 the sheet metal pieces of the stacks 40,.50 are arranged such that their respective narrow sides contact the stator plates 10, 20, 30. The stacks 40, 50 and stator plates 10, 20, 30 are connected to each other only mechanically. In another embodiment of the electric motor the stacks 40, 50 are welded to stator plates 10, 20, 30 to form a material connection. Stator plates 10 and 30 are thus materially connected via their inner sides to the upper and lower sides of stack 40 and stator plates 20 and 30 are materially connected via their inner sides to the upper and lower sides of stack 50, so that a continuous metallic junction of the stacks 40, 50 and stator plates 10, 20, 30 results.

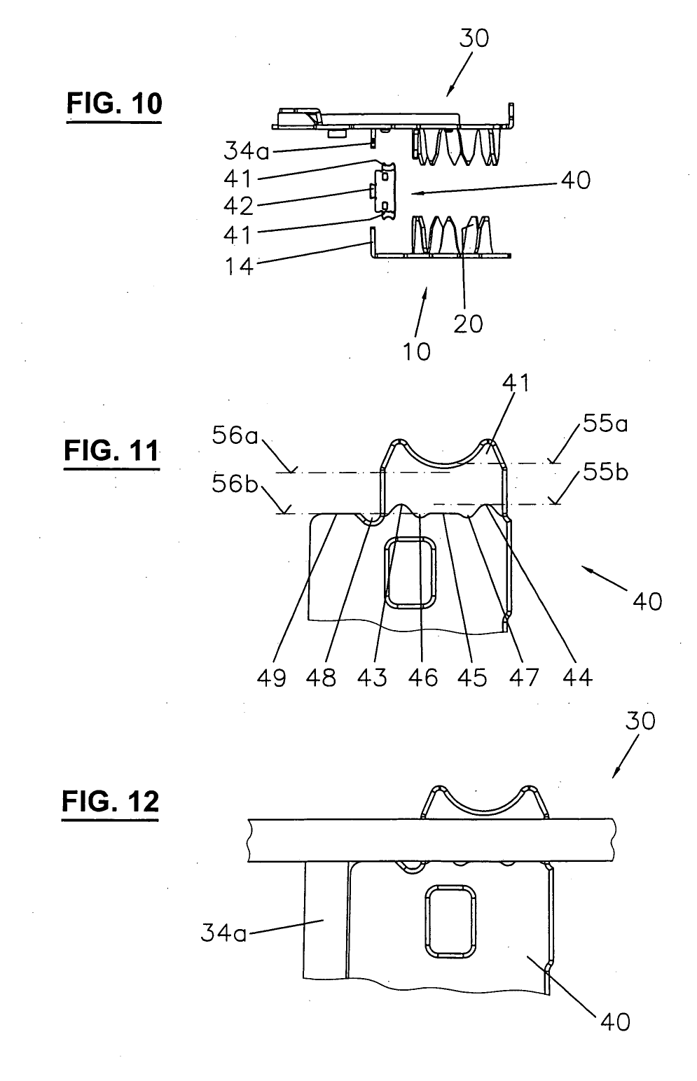

The connecting surfaces of a stack 40, 50 that are intended to form the welding seams have an undulated form before assembling. This is apparent in FIG. 10 and particularly in FIG. 11, which shows the upper side of stack 40 in a detail view. Herebelow, the configuration of this upper side is explained in more detail. The description also applies to the lower side of stack 40 and to the upper and lower sides of stack 50, which have an essentially identical configuration.

The portion of the sheet metal pieces of stack 40 that forms the connecting surface comprises two elevations 43, 44, between which a first contact surface 45 and two indentations 46, 47 are arranged, and—adjacent to the front side of stack 40—another indentation 48 and a second contact surface 49.

The stator can be produced as follows:

The stacks 40, 50 are formed by punching out and joining the sheet metal pieces. The stator plates 10, 20, 30 are formed by punching out and bending.

The coils for supplying the stator with current are placed around stacks 40, 50, and stator portions 10, 20, 30, 40, 50 are assembled such that prolongations 41, 42, 51, 52 engage in corresponding openings 15, 16, 25, 26, 35a, 35b, 36. The elevations of the stacks, e.g. 43 and 44, thus come into contact with the stators plates, e.g. 30. In FIG. 11, the initial position of stator plate 30 is indicated by chain dotted lines 55a, 55b.

Stator portions 10, 20, 30, 40, 50 are pressed together by applying a continuous force, and the junctions between stacks 40, 50 and stator plates 10, 20, 30 are welded together by resistance welding. To this end, a specified voltage e.g. of the order of approx. 10 kV is applied to the stator for a specified time e.g. of the order of 20 to 30 ms. Due to the electric conductivity of stator portions 10, 20, 30, 40, 50, a current flows through the junctions that causes a heating thereof. During the welding procedure, the material forming the elevations, e.g. 43 and 44, is partly or entirely melted and received in indentations, 46 to 48. In the final position, stator plates 10, 20, 30 are in contact with the contact surfaces of stacks 40, 50, as is apparent from FIG. 11, where chain dotted lines 56a, 56b indicate the final position of stator plate 30.

FIG. 12 shows the stack.40 connected to stator plate 30 in a detail view. It is seen that tongue 34a is in contact with the front side of stack 40. In the area where it is welded to stack 40, stator plate 30 is essentially plane. The connecting surface of stator plate 30 that is welded to stack 40 is part of the underside of stator plate 30.

Instead of resistance welding, other welding methods are also possible for forming a material connection at the junctions between stacks 40, 50 and stator members 10, 20, 30, e.g. fusion welding or laser welding.

Welding the stator portions together offers the following advantages:
Due to the improved connection, the noise produced by the electric motor is significantly reduced. Moreover, the mechanical stability of the electric motor is improved.
The welding operation provides a material interconnection and thus a continuous metallic junction. In this manner, the magnetic properties of the stator are improved, since among others the magnetic contact resistance is reduced and the performance is increased. All in all, an electric motor has an improved performance.
Due to the welding technique, the sides of a stack that are connected to the stator plates need not be manufactured with high precision. Usual manufacturing tolerances are sufficient.
The welding operation is a relatively inexpensive production step that can be integrated into an already existing production sequence without problems. The welding operation requires no specific choice of materials for the stator portions. These may still be selected in function of the desired magnetic properties. If the stator plates and/or the sheet metal pieces of the stacks are coated with a varnish, it is possible to weld the stator portions together through the varnish without particular precautions.

The edge of the sheet metal pieces that is welded to a stator plate need not necessarily have a smoothly undulated form, but may also be toothed, serrated, crenelated, or provided with elevations of other shapes that melt during the welding operation.

The two measures described above—providing an additional pole and welding the stack of sheet metal pieces and the stator plate together—can be used independently of each other in order to improve the performance of the electric motor.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. An electric motor comprising:
a first stator member being made of one piece and having n1 teeth;
a second stator member being made of one piece and having n2 teeth;
a third stator member being made of one piece and having n3 teeth,
a tooth of said third stator member being arranged between a tooth of said first stator member and a tooth of said second stator member and n3 being greater than the sum of n1 and n2;
a first connecting element that is in contact with said first stator member and said third stator member;
a second connecting element that is in contact with said second stator member and said third stator member;
a first coil that is arranged between said first stator member and said third stator member;
a second coil that is arranged between said second stator member and said third stator member; and
a rotor that is arranged in a cage formed by said teeth of said stator members.

2. The electric motor of claim 1, wherein n1+n2+1=n3.

3. The electric motor of claim 1, wherein said stator members are each formed of a sheet metal piece comprising bent prolongations for forming said teeth.

4. The electric motor of claim 1, wherein said connecting elements are each in the form of a stack of sheet metal pieces that are joined to each other.

5. The electric motor of claim 4, wherein said first stator member and said third stator member are welded to the narrow sides of the sheet metal pieces of said first connecting element, and wherein said second stator member and said third stator member are welded to the narrow sides of the sheet metal pieces of said second connecting element.

6. The electric motor of claim 4, wherein said sheet metal pieces are soft magnetic.

7. The electric motor of claim 1, wherein said connecting elements have prolongations that engage in openings in said stator members.

8. The electric motor of claim 1, wherein said first stator member comprises a first bent tongue that is in contact with said first connecting element, and said second stator member comprises a second bent tongue that is in contact with said second connecting element.

9. The electric motor of claim 1, wherein said third stator member comprises a third bent tongue that is in contact with said first connecting element, and a fourth bent tongue that is in contact with said second connecting element.

10. The electric motor of claim 1, wherein said first and second coils are arranged adjacent to each other and the axis of rotation of said rotor is located outside the area between said first and second coils.

11. The electric motor of claim 1, wherein said third stator member serves as a support plate for a gear assembly that is coupled to said rotor.

12. An electric motor having a stator that comprises a first stack of sheet metal pieces that are joined to each other and a first stator plate, wherein said stator plate is welded to the narrow sides of said sheet metal pieces.

13. The electric motor of claim 12, wherein said stator plate has bent teeth for forming poles.

14. The electric motor of claim 12, wherein said first stator plate has a bent tongue that is in contact with said first stack.

15. The electric motor of claim 12, wherein said first stack has at least one prolongation that engages in an opening formed in said first stator plate.

16. The electric motor of claim 12, further comprising a second stator plate that is welded to said first stack.

17. The electric motor of claim 16, further comprising a coil that is arranged between said first stator plate and said second stator plate, and a rotor that is arranged adjacent to said coil.

18. The electric motor of claim 12, further comprising two coils that are arranged side by side, and a rotor whose axis of rotation is located outside the area between said two coils.

19. The electric motor of claim 12, further comprising a second stator plate that is connected to said first stator plate by means of a second stack of sheet metal pieces being joined to each other.

20. The electric motor of claim 12, further comprising a rotor and a circuit for the stepwise operation of said rotor.

21. The electric motor of claim 12, wherein said first stator plate is essentially plane in the area where it is welded to said first stack.

22. The electric motor of claim,12, wherein said first stack is welded to an integrally formed connecting surface of said first stator plate.
